(19) United States
(12) Patent Application Publication
(10) Pub. No.: US 2014/0148985 A1
(43) Pub. Date: May 29, 2014

(54) CONTROL SYSTEM AND CONTROL METHOD FOR HYBRID VEHICLE

(71) Applicants: Shun SATO, Toyota-shi (JP); Toshio SUGIMURA, Nagoya-shi (JP); Seiji KUWAHARA, Toyota-shi (JP); Takahiko TSUTSUMI, Nisshin-shi (JP); Koki MINAMIKAWA, Nagoya-shi (JP)

(72) Inventors: Shun SATO, Toyota-shi (JP); Toshio SUGIMURA, Nagoya-shi (JP); Seiji KUWAHARA, Toyota-shi (JP); Takahiko TSUTSUMI, Nisshin-shi (JP); Koki MINAMIKAWA, Nagoya-shi (JP)

(73) Assignee: TOYOTA JIDOSHA KABUSHIKI KAISHA, Toyota-shi (JP)

(21) Appl. No.: 14/086,379

(22) Filed: Nov. 21, 2013

(30) Foreign Application Priority Data
Nov. 24, 2012 (JP) 2012-256980

(51) Int. Cl. B60W 20/00

(52) U.S. Cl. CPC B60W 20/00; Y10S 903/903
USPC 701/22; 180/65.29; 903/903

(57) ABSTRACT

A control system for a hybrid vehicle includes a controller. When a downshift of a transmission and an increase in an amount of regeneration are carried out during regenerative coast traveling in which regeneration is carried out by an electric motor, and when a state of charge of a battery is lower than a predetermined value, the controller increases the amount of regeneration before completion of the downshift. When the state of charge of the battery is higher than or equal to the predetermined value, the controller increases the amount of regeneration after completion of the downshift.

### INCORPORATION BY REFERENCE

The disclosure of Japanese Patent Application No. 2012-256980 filed on Nov. 24, 2012 including the specification, drawings and abstract is incorporated herein by reference in its entirety.

### BACKGROUND OF THE INVENTION

1. Field of the Invention

The invention relates to a control system and control method for a hybrid vehicle and, more particularly, to shift control during regenerative coast traveling.

2. Description of Related Art

There is widely known a hybrid vehicle that includes an engine and an electric motor, each of which functions as a driving force source, and a transmission provided in a power transmission path between drive wheels and both the engine and the electric motor. The thus configured hybrid vehicle is able to travel by appropriately switching into an engine drive mode or a motor drive mode. In the engine drive mode, the hybrid vehicle travels mainly using the driving force of the engine. In the motor drive mode, the hybrid vehicle travels with the use of only the electric motor as a driving force source. In addition, during coast traveling, so-called regenerative coast traveling in which regenerative torque of the electric motor is regenerated may be carried out. In the coast traveling, the hybrid vehicle travels in a state where supply of fuel to the engine is stopped. During such regenerative coast traveling, when a downshift condition of the transmission is satisfied, a downshift of the transmission is started. Furthermore, when a brake is, for example, depressed by a driver during the downshift, an increase in the amount of regeneration is required in order to increase the braking force of the vehicle. If the amount of regeneration is increased during such a downshift, it is required to increase the torque capacity of the transmission with an increase in the amount of regeneration, with the result that it is required to increase clutch hydraulic pressure during shifting. However, the response of the clutch hydraulic pressure and the response of the electric motor generally differ from each other, so it is difficult to match an increase in the amount of regeneration with the timing of an increase in the clutch hydraulic pressure, and there may occur, for example, steep engagement, or the like, of a clutch, and drivability may deteriorate. In contrast to this, Japanese Patent Application Publication No. 2011-199959 (JP 2011-199959 A) describes a technique for, when an increase in the amount of regeneration is required at the time of a downshift during regenerative coast traveling in which a vehicle carries out coast traveling with regeneration of an electric motor, preventing deterioration of drivability by suppressing the increase in the amount of regeneration.

However, in control described in JP 2011-199959 A, an increase in the amount of regeneration is suppressed until completion of the shift, so the amount of electric power generated through regeneration may reduce as compared to that when the amount of regeneration is increased, and it may be difficult to improve fuel economy.

### SUMMARY OF THE INVENTION

The invention provides a control device for a hybrid vehicle that includes an engine and an electric motor, each of which functions as a driving force source, and a transmission provided between a drive wheel and both the engine and the electric motor, the control device being able to suppress deterioration of drivability and deterioration of fuel economy at the time when a request to increase the amount of regeneration is output at the time of a downshift during regenerative coast traveling.

A first aspect of the invention provides a control system for a hybrid vehicle. The control system includes an engine, an electric motor, a transmission, a battery and a controller. The engine and the electric motor each serve as a driving force source. The transmission is provided on a power transmission path between a drive wheel and both the engine and the electric motor. The battery is configured to exchange electric power with the electric motor. When a downshift of a transmission and an increase in an amount of regeneration are carried out during regenerative coast traveling in which regeneration is carried out by an electric motor, and when a state of charge of a battery is lower than a predetermined value, the controller increases the amount of regeneration before completion of the downshift. When the state of charge of the battery is higher than or equal to the predetermined value, the controller increases the amount of regeneration after completion of the downshift.

With this configuration, when the state of charge of the battery is lower than the predetermined value, an increase in the amount of regeneration carried out by the electric motor is carried out before completion of the downshift, so it is possible to quickly ensure the state of charge. On the other hand, when the state of charge of the battery is higher than or equal to the predetermined value, an increase in the amount of regeneration is carried out after completion of the downshift. Thus, it is possible to suppress deterioration of drivability at the time of the shift. In this way, by changing the timing of starting an increase in the amount of regeneration on the basis of the state of charge of the battery, it is possible to suppress deterioration of drivability and deterioration of fuel economy.

A second aspect of the invention provides a control method for a hybrid vehicle. The hybrid vehicle includes an engine, an electric motor, a transmission and a battery. The engine and the electric motor each serve as a driving force source. The transmission is provided on a power transmission path between a drive wheel and both the engine and the electric motor. The battery is configured to exchange electric power with the electric motor. The control method includes: starting a downshift of the transmission during regenerative coast traveling in which regeneration is carried out by the electric motor; detecting a request to increase an amount of regeneration carried out by the electric motor; determining whether a state of charge of the battery is higher than or equal to a predetermined value; and increasing the amount of regeneration before completion of the downshift when the state of charge of the battery is lower than the predetermined value, and increasing the amount of regeneration after completion of the downshift when the state of charge of the battery is higher than or equal to the predetermined value.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view that illustrates the schematic configuration of a power transmission path from an engine to drive wheels, which constitute a hybrid vehicle according to an embodiment of the invention, and is a view that illustrates a relevant portion of a control system provided in the vehicle for output control over the engine that functions as a driving force source, shift control over an automatic transmission, drive control over the electric motor, and the like;

FIG. 2 is a functional block diagram that illustrates a relevant portion of control functions implemented by an electronic control unit shown in FIG. 1;

FIG. 3 is a flowchart for illustrating a relevant portion of control operations of the electronic control unit shown in FIG. 1, that is, control operations at the time when a request to increase an amount of regeneration is output at the time of a downshift during regenerative coast traveling;

FIG. 4 is a time chart that shows operation results of the flowchart shown in FIG. 3;

FIG. 5 is another time chart that shows operation results of the flowchart shown in FIG. 3; and

FIG. 6 is a graph that shows the correlation between a state of charge and a delay time from when the request to increase the amount of regeneration is output according to another embodiment of the invention.

### DETAILED DESCRIPTION OF EMBODIMENTS

Here, preferably, regenerative coast traveling corresponds to a drive mode in which regeneration is carried out by an electric motor during coast traveling. Coast traveling includes coasting and decelerating.

Hereinafter, an embodiment of the invention will be described in detail with reference to the accompanying drawings. In the following embodiment, the drawings are simplified or deformed as needed, and the scale ratio, shapes, and the like, of portions are not always accurately drawn.

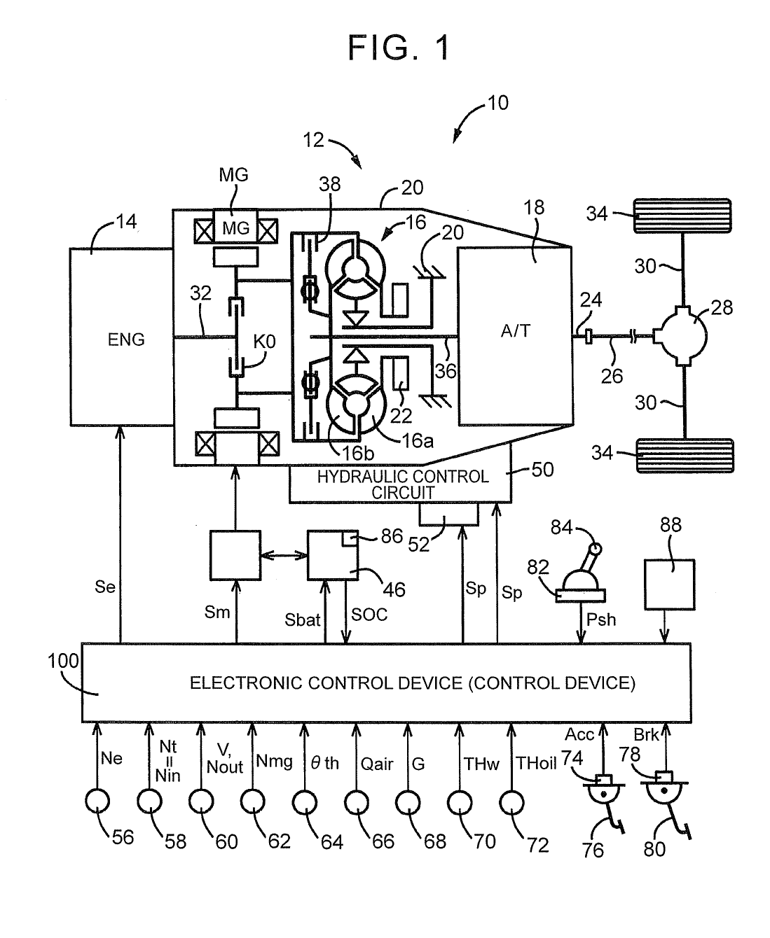

FIG. 1 is a view that illustrates the schematic configuration of a power transmission path from an engine 14 and an electric motor MG to drive wheels 34, which constitute a hybrid vehicle 10 (hereinafter, referred to as vehicle 10). FIG. 1 is a view that illustrates a relevant portion of a control system provided in the vehicle 10 for output control over the engine 14 that functions as a driving force source, shift control over an automatic transmission 18, drive control over the electric motor MG, and the like.

In FIG. 1, a vehicle power transmission device 12 (hereinafter, referred to as power transmission device 12) includes an engine separating clutch K0 (hereinafter, referred to as clutch K0), the electric motor MG, a torque converter 16, an oil pump 22, the automatic transmission 18, and the like, sequentially from the engine 14 side in a transmission case 20 (hereinafter, referred to as case 20). The case 20 serves as a non-rotating member connected to a vehicle body by a bolt, or the like. The power transmission device 12 includes a propeller shaft 26, a differential gear unit (differential gear) 28, a pair of axles 30, and the like. The propeller shaft 26 is coupled to an output shaft 24 that is an output rotating member of the automatic transmission 18. The differential gear unit 28 is coupled to the propeller shaft 26. The pair of axles 30 are coupled to the differential gear unit 28. The thus configured power transmission device 12 is, for example, suitably used for the front-engine, rear-drive (FR) vehicle 10. In the power transmission device 12, when the clutch K0 is engaged, the power of the engine 14 is transmitted from an engine coupling shaft 32 to the pair of drive wheels 34 via the clutch K0, the torque converter 16, the automatic transmission 18, the propeller shaft 26, the differential gear unit 28, the pair of axles 30, and the like. The engine coupling shaft 32 couples the engine 14 to the clutch K0.

The torque converter 16 is a fluid transmission device that transmits driving force, input to a pump impeller 16a, to the automatic transmission 18 side via fluid. The pump impeller 16a is coupled to the engine 14 via the clutch K0 and the engine coupling shaft 32, and is an input-side rotating element that receives driving force from the engine 14 and that is rotatable around its axis. A turbine impeller 16b of the torque converter 16 is an output-side rotating element of the torque converter 16. The turbine impeller 16b is coupled to a transmission input shaft 36 by spline fitting, or the like. The transmission input shaft 36 is an input rotating member of the automatic transmission 18. The turbine impeller 16b is relatively non-rotatable with respect to the transmission input shaft 36. The torque converter 16 includes a lockup clutch 38. The lockup clutch 38 is a direct coupling clutch provided between the pump impeller 16a and the turbine impeller 16b, and is placed in an engaged state, a slipped state or a released state through hydraulic pressure control, or the like.

The electric motor MG is a so-called motor generator having the function of a motor that generates mechanical driving force from electric energy and the function of a generator that generates electric energy from mechanical energy. In other words, the electric motor MG can function as a driving force source that generates driving force instead of the engine 14 that is a power source or together with the engine 14. In addition, the electric motor MG generates electric energy through regeneration from driving force generated by the engine 14 or driven force input from the drive wheels 34 side, and operates to, for example, store the electric energy in a battery 46 via an inverter 40, a step-up converter (not shown), and the like. The battery 46 is an electrical storage device. Driven force input from the drive wheels 34 side may be regarded as mechanical energy. The electric motor MG is operably coupled to the pump impeller 16a, and power is transmitted to each other between the electric motor MG and the pump impeller 16a. Thus, the electric motor MG, as well as the engine 14, is coupled to the transmission input shaft 36 such that power is transmittable. The electric motor MG is connected so as to exchange electric power with the battery 46 via the inverter 40, the step-up converter (not shown), and the like. When the vehicle travels with the use of the electric motor MG as the driving force source, the clutch K0 is released, and the power of the electric motor MG is transmitted to the pair of drive wheels 34 via the torque converter 16, the automatic transmission 18, the propeller shaft 26, the differential gear unit 28, the pair of axles 30, and the like.

The oil pump 22 is coupled to the pump impeller 16a, and is a mechanical oil pump that generates hydraulic pressure by being driven for rotation by the engine 14 or the electric motor MG for executing shift control over the automatic transmission 18, controlling the torque capacity of the lockup clutch 38, controlling engagement or release of the clutch K0, and supplying lubricant to the portions of the power transmission path of the vehicle 10. The power transmission device 12 includes an electric oil pump 52 that is driven by an electric motor (not shown), and, when the oil pump 22 is not driven, for example, when the vehicle is stopped, generates hydraulic fluid by supplementarily operating the electric oil pump 52.

The clutch K0 is, for example, a wet-type multi-disc hydraulic friction engagement device in which a plurality of friction plates are overlapped on top of each other are pressed by a hydraulic actuator, and undergoes engagement/release control by a hydraulic control circuit 50 provided in the power transmission device 12 using a hydraulic pressure, generated by the oil pump 22 or the electric oil pump 52, as a source pressure. In the engagement/release control, the torque capacity that the clutch K0 is able to transmit, that is, the engagement force of the clutch K0, is, for example, continuously varied by regulating a pressure of a linear solenoid valve, or the like, in the hydraulic control circuit 50. The clutch K0 includes a pair of clutch rotating members that are relatively rotatably in a released state of the clutch K0. One of the clutch rotating members is coupled to the engine coupling shaft 32 so as to be relatively non-rotatable; whereas the other one of the clutch rotating members is coupled to the pump impeller 16a of the torque converter 16 so as to be relatively non-rotatable. The pair of clutch rotating members are a clutch hub and a clutch drum. For example, the clutch hub is coupled to the engine coupling shaft 32 so as to be relatively non-rotatable; whereas the clutch drum is coupled to the pump impeller 16a so as to be relatively non-rotatable. With this configuration, when the clutch K0 is in the engaged state, the pump impeller 16a is caused to integrally rotate with the engine 14 via the engine coupling shaft 32. That is, in the engaged state of the clutch K0, driving force from the engine 14 is input to the pump impeller 16a. On the other hand, in the released state of the clutch K0, power transmission between the pump impeller 16a and the engine 14 is interrupted. As described above, the electric motor MG is operably coupled to the pump impeller 16a, so the clutch K0 functions as a clutch that connects or disconnects the power transmission path between the engine 14 and the electric motor MG. A so-called normally-open clutch is used as the clutch K0 according to the present embodiment. The normally-open clutch increases its torque capacity (engagement force) in proportion to a hydraulic pressure, and is placed in the released state in a state where no hydraulic pressure is supplied.

The automatic transmission 18 is coupled to the electric motor MG not via the clutch K0 such that power is transmittable. The automatic transmission 18 constitutes part of the power transmission path from the engine 14 and the electric motor MG to the drive wheels 34. The automatic transmission 18 transmits power from the driving force sources, that is, the engine 14 and the electric motor MG, to the drive wheels 34 side. The automatic transmission 18 is, for example, a planetary gear-type multistage transmission that functions as a step-shift automatic transmission in which a plurality of speed positions (gear positions) are selectively established through shifting by switching an engaged one of a plurality of engagement devices, for example, hydraulic friction engagement devices, such as clutches C and brakes B. Switching an engaged one of the hydraulic friction engagement devices includes engaging one of the hydraulic friction engagement devices and releasing another one of the friction engagement devices. That is, the automatic transmission 18 is a step-shift transmission that carries out so-called clutch-to-clutch shift that is widely used in a known vehicle, and outputs the rotation of the transmission input shaft 36 from the output shaft 24 while changing the speed of the rotation. The transmission input shaft 36 is also a turbine shaft that is driven for rotation by the turbine impeller 16b of the torque converter 16. Then, in the automatic transmission 18, a predetermined speed position is established through engagement/release control over each of the clutches C and brakes B On the basis of driver's accelerator operation, a vehicle speed V, and the like. The automatic transmission 18 is placed in a neutral state when any of the clutches C and brakes B of the automatic transmission 18 are released, and the power transmission path between the drive wheels 34 and both the engine 14 and the electric motor MG is disconnected. The automatic transmission 18 is an example of a transmission according to the invention.

Referring back to FIG. 1, the vehicle 10 includes an electronic control unit 100 that includes a control unit associated with, for example, hybrid drive control, or the like. The electronic control unit 100 is configured to include a so-called microcomputer that includes, for example, a CPU, a RAM, a ROM, an input/output interface, and the like. The CPU executes various controls over the vehicle 10 by executing signal processing in accordance with programs prestored in the ROM while utilizing the temporary storage function of the RAM. For example, the electronic control unit 100 is configured to execute output control over the engine 14, drive control over the electric motor MG, including regenerative control over the electric motor MG, shift control over the automatic transmission 18, torque capacity control over the lockup clutch 38, torque capacity control over the clutch K0, and the like, and is, where necessary, separated into an engine control electronic control unit, an electric motor control electronic control unit, a hydraulic control electronic control unit, that is, a shift control electronic control unit, and the like.

For example, a signal indicating an engine rotation speed Ne, a signal indicating a transmission input rotation speed Nin, a signal indicating a transmission output rotation speed Nout, a signal indicating an electric motor rotation speed Nmg, a signal indicating a throttle valve opening degree θth, a signal indicating an intake air amount Qair of the engine 14, a signal indicating a longitudinal acceleration G (or a longitudinal deceleration G) of the vehicle 10, a signal indicating a coolant temperature THw of the engine 14, a signal indicating a fluid temperature THoil of hydraulic fluid in the hydraulic control circuit 50, a signal indicating an accelerator operation amount Acc, a signal indicating a brake operation amount Brk, a signal indicating a lever position (shift operation position, shift position, operation position) Psh of a shift lever 84, a state of charge (charged level, remaining level of charge) SOC of the battery 46, and the like, are supplied to the electronic control unit 100. The engine rotation speed Ne is the rotation speed of the engine 14, and is detected by an engine rotation speed sensor 56. The transmission input rotation speed Nin is a turbine rotation speed Nt of the torque converter 16, that is, the rotation speed of the transmission input shaft 36, as the input rotation speed of the automatic transmission 18, and is detected by a turbine rotation speed sensor 58. The transmission output rotation speed Nout is the rotation speed of the output shaft 24, corresponds to the vehicle speed V, the rotation speed of the propeller shaft 26, and the like, as a vehicle speed related value, and is detected by an output shaft rotation speed sensor 60. The electric motor rotation speed Nmg is the rotation speed of the electric motor MG, and is detected by an electric motor rotation speed sensor 62. The throttle valve opening degree θth is the opening degree of an electronic throttle valve (not shown), and is detected by a throttle sensor 64. The intake air amount Qair is detected by an intake air amount sensor 66. The longitudinal acceleration G (or the longitudinal deceleration G) is detected by an acceleration sensor 68. The coolant temperature THw is detected by a coolant temperature sensor 70. The fluid temperature THoil of hydraulic fluid is detected by a fluid temperature sensor 72. The accelerator operation amount Acc is the operation amount of an accelerator pedal 76 as a driver's driving force required amount (driver required power) to the vehicle 10, and is detected by an accelerator operation amount sensor 74. The brake operation amount Brk is the operation amount of a brake pedal 80 as a driver's braking force required amount (driver required deceleration) to the vehicle 10, and is detected by a foot brake sensor 78. The lever position Psh, such as known “P”, “N”, “D”, “R”, “S” positions, and the like, is detected by a shift position sensor 82. The state of charge SOC is detected by a battery sensor 86. In addition, electric power is supplied from an auxiliary battery 88 to the electronic control unit 100. The auxiliary battery 88 is charged with electric power stepped down by a DC/DC converter (not shown).

In addition, for example, an engine output control command signal Se for output control over the engine 14, an electric motor control command signal Sm for controlling operation of the electric motor MG, a hydraulic pressure command signal Sp for actuating electromagnetic valves, the electric oil pump 52, and the like, included in the hydraulic control circuit 50 in order to control the hydraulic actuator of the clutch K0 and the hydraulic actuators of the clutches C and brakes B of the automatic transmission 18, and the like, are output from the electronic control unit 100.

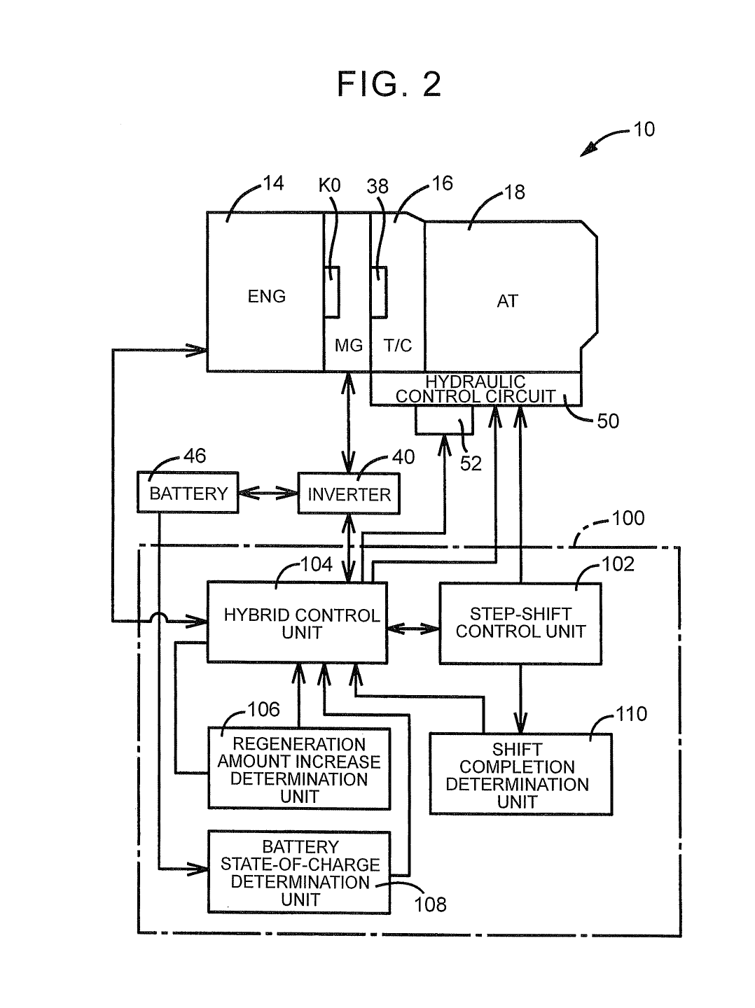

FIG. 2 is a functional block diagram that illustrates a relevant portion of control functions implemented by the electronic control unit 100. In FIG. 2, step-shift control means, that is, a step-shift control unit 102, functions as a shift control unit that shifts the automatic transmission 18. The step-shift control unit 102, for example, determines whether to shift the automatic transmission 18, that is, a speed position to which the automatic transmission 18 should be shifted, on the basis of a vehicle state indicated by the actual vehicle speed V and the accelerator operation amount Acc by consulting a prestored known correlation (shift line map, shift map) having upshift lines and downshift lines using the vehicle speed V and the accelerator operation amount Acc, the transmission output torque Tout, or the like, as variables. Then, the step-shift control unit 102 executes automatic shift control over the automatic transmission 18 such that the determined speed position is obtained. For example, the step-shift control unit 102 determines that a request to downshift the automatic transmission 18 is issued when the accelerator operation amount Acc (vehicle required torque) crosses any one of the downshift lines toward a high accelerator operation amount (high vehicle required torque) side with an increase in the accelerator operation amount Acc as a result of further depressing operation of the accelerator pedal 76, and executes downshift control over the automatic transmission 18 corresponding to the downshift line. At this time, the step-shift control unit 102, for example, outputs the command (shift output command, hydraulic pressure command) Sp for engaging and/or releasing the engagement devices associated with the shift of the automatic transmission 18 to the hydraulic control circuit 50 such that a speed position is achieved in accordance with a prestored predetermined engagement operation chart. The hydraulic control circuit 50 actuates the hydraulic actuators of the engagement devices associated with the shift by actuating the solenoid valves in the hydraulic control circuit 50 in accordance with the command Sp such that the automatic transmission 18 is shifted by releasing the releasing-side clutch and engaging the engaging-side clutch.

Hybrid control means, that is, a hybrid control unit 104, includes the function of an engine drive control unit that executes drive control over the engine 14 and the function of an electric motor operation control unit that controls operation of the electric motor MG via the inverter 40 as the driving force source or the generator. The hybrid control unit 104 executes hybrid drive control, or the like, with the use of the engine 14 and the electric motor MG through those control functions. For example, the hybrid control unit 104 calculates the vehicle required torque on the basis of the accelerator operation amount Acc and the vehicle speed V, and controls the driving force sources in consideration of a transmission loss, an auxiliary load, the speed position of the automatic transmission 18, the state of charge SOC of the battery 46, and the like, such that the vehicle required torque is obtained by the output torque of the driving force sources.

More specifically, for example, within a range in which the vehicle required torque is provided by only the output torque (electric motor torque) Tmg of the electric motor MG, the hybrid control unit 104 sets a drive mode to a motor drive mode (hereinafter, EV drive mode), and carries out motor traveling (EV traveling) in which only the electric motor MG is used as the driving force source. On the other hand, for example, within a range in which the vehicle required torque is not provided without at least the output torque (engine torque) Te of the engine 14, the hybrid control unit 104 sets the drive mode to an engine drive mode, and carries out engine traveling in which at least the engine 14 is used as the driving force source.

When the hybrid control unit 104 carries out EV traveling, the hybrid control unit 104 disconnects the power transmission path between the engine 14 and the torque converter 16 by releasing the clutch K0, and causes the electric motor MG to output the electric motor torque Tmg required for motor traveling. On the other hand, when the hybrid control unit 104 carries out engine traveling, the hybrid control unit 104 transmits driving force from the engine 14 to the pump impeller 16a by engaging the clutch K0, and, where necessary, causes the electric motor MG to output assist torque. For example, when the hybrid control unit 104 does not drive the oil pump 22, for example, during a stop of the vehicle, the hybrid control unit 104 prevents shortage of hydraulic fluid by supplementarily actuating the electric oil pump 52.

When the depression amount of the accelerator pedal 76, for example, increases and the vehicle required torque increases during EV traveling, and then the electric motor torque Tmg required for EV traveling corresponding to the vehicle required torque exceeds a predetermined EV traveling torque range in which EV traveling is possible, the hybrid control unit 104 shifts the drive mode from the EV drive mode to the engine drive mode, and carries out engine traveling by starting the engine 14. At the time of a start of the engine 14, the hybrid control unit 104 engages the clutch K0 toward complete engagement and drives the engine 14 for rotation by transmitting engine start torque Tmgs for starting the engine from the electric motor MG via the clutch K0. Thus, the engine 14 is started by controlling engine ignition, fuel supply, and the like, while increasing the engine rotation speed Ne to a predetermined rotation speed or higher. The hybrid control unit 104 quickly completely engages the clutch K0 after a start of the engine 14.

For example, during coast traveling in which an accelerator is off or during braking through depression of the brake pedal 80, the hybrid control unit 104 functions as regenerative control means for causing the electric motor MG to be driven for rotation to operate as a generator using kinetic energy of the vehicle 10, that is, counter driving force that is transmitted from the drive wheels 34 to the engine 14 side, in order to improve fuel economy, and for charging the battery 46 with the electric energy via the inverter 40. In the regenerative control, an amount of regeneration is controlled so as to be an amount of regeneration determined on the basis of the state of charge SOC of the battery 46, the distribution of braking force caused by hydraulic brake for Obtaining braking force based on the brake pedal operation amount, and the like. In the specification, traveling in which regenerative control is executed during coast traveling is defined as regenerative coast traveling. During the regenerative control, the lockup clutch 38 is engaged.

During such regenerative coast traveling, when a downshift condition of the automatic transmission 18 is satisfied, for example, when the vehicle speed V decreases and crosses the preset downshift line, a start of the downshift is determined. The step-shift control unit 102 starts a downshift of the automatic transmission 18. Here, for example, when the brake pedal 80 is depressed in a transitional phase of the downshift during regenerative coast traveling, a request to increase the amount of regeneration of the electric motor MG may be output in order to increase the braking force of the vehicle 10. In such a case, the torque capacity of the automatic transmission 18 increases with an increase in the amount of regeneration, so it is required to increase the clutch hydraulic pressure of the engaging-side clutch. However, the response of the clutch hydraulic pressure and the response of the electric motor MG differ from each other, and, specifically, the response of the electric motor MG is higher than the response of the clutch hydraulic pressure, so it is actually difficult to optimize an increase in the amount of regeneration and the timing of an increase in the clutch hydraulic pressure. Thus, for example, a shock may occur due to clutch steep engagement, or the like, and drivability may deteriorate. In contrast to this, in order to prevent deterioration of drivability, if an increase in the amount of regeneration is always prohibited during shifting, sufficient regeneration may not be carried out and fuel economy may deteriorate.

Therefore, in the present embodiment, in the case where a downshift of the automatic transmission 18 and an increase in the amount of regeneration are carried out during regenerative coast traveling, an increase in the amount of regeneration is carried out by the electric motor MG before completion of the downshift when the state of charge SOC of the battery 46 is lower than a predetermined value α; whereas an increase in the amount of regeneration is carried out after completion of the downshift when the state of charge SOC is higher than or equal to the predetermined value α.

When the state of charge SOC of the battery 46 is low, the necessity to charge the battery 46 by carrying out regeneration is higher than that when the state of charge SOC is high. In such a case, it is desirable to quickly increase the amount of regeneration in order to increase (ensure) the state of charge SOC. Thus, the hybrid control unit 104 increases the amount of regeneration carried out by the electric motor MG before completion of the downshift when the state of charge SOC becomes lower than the predetermined value α.

On the other hand, when the state of charge SOC increases, the necessity to carry out regeneration, that is, the necessity to carry out charging operation, becomes lower than that when the state of charge SOC is low. In such a case, it is desirable to suppress deterioration of drivability due to an increase in the amount of regeneration in a transitional phase of the downshift. Thus, the hybrid control unit 104 increases the amount of regeneration after completion of the downshift when the state of charge SOC becomes higher than or equal to the predetermined value α. When the state of charge SOC becomes higher than or equal to the preset predetermined value α, the necessity to carry out regeneration decreases. In such a case, by increasing the amount of regeneration after completion of the downshift of the automatic transmission 18, a shock is further suppressed, and deterioration of drivability is also suppressed. The predetermined value α is obtained through an experiment or analysis in advance, and is, for example, set to a state of charge SOC at which EV traveling can be carried out for only a preset predetermined period of time.

Referring back to FIG. 2, regeneration amount increase determination means, that is, a regeneration amount increase determination unit 106, determines whether a request to increase the amount of regeneration is output. For example, depression operation of the brake pedal 80, or the like, corresponds to a request to increase the amount of regeneration. Thus, the regeneration amount increase determination unit 106 determines whether there is a request to increase the amount of regeneration by detecting depression of the brake pedal 80.

When battery state-of-charge determination means, that is, a battery state-of-charge determination unit 108, determines that a request to increase the amount of regeneration is output by the regeneration amount increase determination unit 106, the battery state-of-charge determination unit 108 determines whether the state of charge SOC of the battery 46 is higher than or equal to the preset predetermined value α. When the battery state-of-charge determination unit 108 determines that the state of charge SOC is higher than or equal to the predetermined value α, the hybrid control unit 104 delays the timing of an increase in the amount of regeneration to timing after completion of the downshift in order to give higher priority to suppressing deterioration of drivability. When the state of charge SOC is lower than the predetermined value α, the hybrid control unit 104 starts increasing the amount of regeneration before completion of the downshift in order to give higher priority to ensuring the state of charge SOC.

Shift completion determination means, that is, a shift completion determination unit 110, determines whether the downshift of the automatic transmission 18 has been completed. Completion of the shift is, for example, determined when the rotation speed Nin of the transmission input shaft 36 has reached a target rotation speed Naim that is set as a rotation speed after the shift. When the shift completion determination unit 110 determines that the shift has been completed, the hybrid control unit 104 starts the delayed increase in the amount of regeneration. The target rotation speed set as a rotation speed after the shift is calculated by the product (=Nout×γ) of the output rotation speed Nout of the output shaft 24 and a post-shift speed ratio γ of the automatic transmission 18.

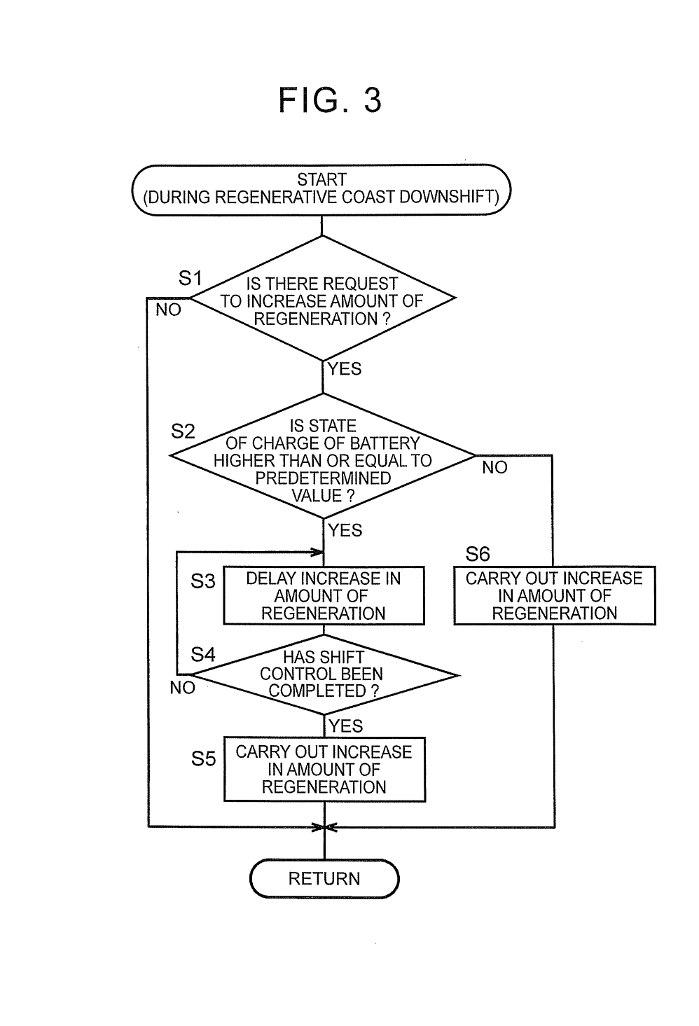

FIG. 3 is a flowchart for illustrating control operations of the electronic control unit 100. That is, FIG. 3 is a flowchart for illustrating control operations at the time when a request to further increase the amount of regeneration is output in a transitional phase at the time of a downshift during regenerative coast traveling. For example, the flowchart is repeatedly executed in an extremely short cycle time of about several milliseconds to several tens of milliseconds. It is assumed that, in the flowchart shown in FIG. 3, a downshift of the automatic transmission 18 is carried out during regenerative coast traveling.

Initially, in Si corresponding to the regeneration amount increase determination unit 106, it is determined whether a request to increase the amount of regeneration carried out by the electric motor MG is output. When negative determination is made in Si, the routine is ended. When affirmative determination is made in S1, it is determined in S2 corresponding to the battery state-of-charge determination unit 108 whether the state of charge SOC of the battery 46 is higher than or equal to the preset predetermined value α. When negative determination is made in S2, an increase in the amount of regeneration is carried out in S6 corresponding to the hybrid control unit 104. That is, an increase in the state of charge SOC is given higher priority because the state of charge SOC is low, and an increase in the amount of regeneration is carried out before completion of the downshift. On the other hand, when affirmative determination is made in S2, an increase in the amount of regeneration is delayed in S3 corresponding to the hybrid control unit 104. In S4 corresponding to the shift completion determination unit 110, it is determined whether shift control over the automatic transmission 18 has been completed. When negative determination is made in S4, the process returns to S3, and an increase in the amount of regeneration is continuously delayed. When affirmative determination is made in S4, that is, it is determined that shift control has been completed, an increase in the amount of regeneration is carried out in S5. In this way, an increase in the amount of regeneration is carried out after the downshift has been completed, so a shock is suppressed, and deterioration of drivability is suppressed.

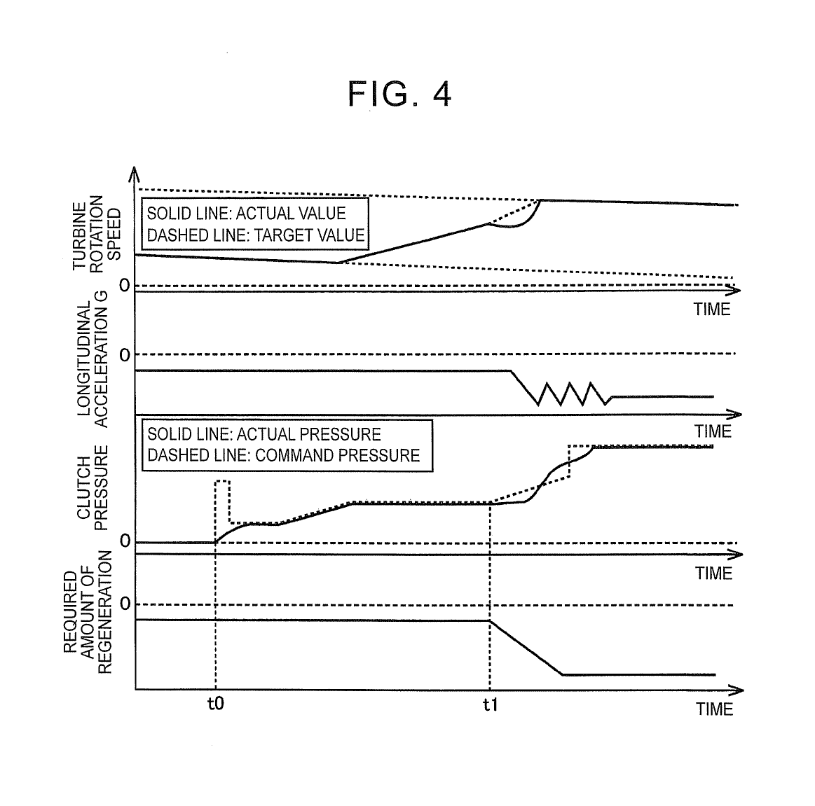

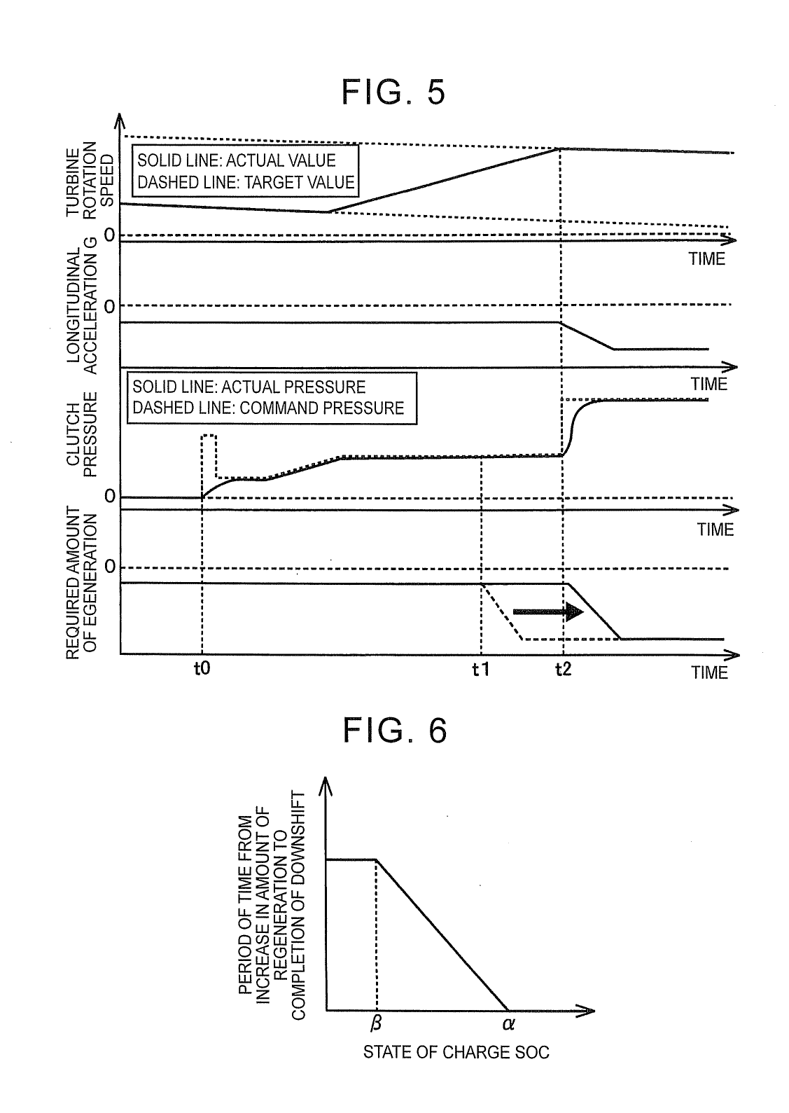

In the flowchart shown in FIG. 3, a time chart corresponding to step S6 is shown in FIG. 4, and a time chart corresponding to step S3 to step S5 is shown in FIG. 5. In FIG. 4 and FIG. 5, the abscissa axis represents time, and the ordinate axes represent a turbine rotation speed Nt (=Nin), a longitudinal acceleration G, a clutch pressure of the engaging-side clutch and a required amount of regeneration (amount of regeneration) of the electric motor MG sequentially from the top. First, description will be made on the case of step S6 shown in FIG. 4, that is, the case where it is determined that the state of charge SOC is lower than the predetermined value α and an increase in the amount of regeneration is carried out preferentially. In FIG. 4, the downshift of the automatic transmission 18 is started at t0 timing, and the clutch pressure (actual pressure) of the engaging-side clutch gradually increases as indicated by the solid line. The required amount of regeneration at this time is the same as that in a state before the shift. When the clutch pressure increases to a predetermined value, inertia phase begins, and the turbine rotation speed Nt increases. Here, when a request to increase the amount of regeneration is output at t1 timing, the required amount of regeneration carried out by the electric motor MG increases. Accordingly, it is necessary to increase the torque capacity of the automatic transmission 18, so the clutch pressure (command pressure) indicated by the dashed line is also increased similarly. However, when there occurs a deviation in clutch pressure between the actual pressure indicated by the solid line and the corrimand pressure indicated by the dashed line, there also occurs a deviation in the turbine rotation speed Nt between an actual value (solid line) and a target value (dashed line), and a shock indicated by the longitudinal acceleration G tends to occur. However, the amount of regeneration is increased without delay during the downshift, so the state of charge SOC increases. Thus, it is possible to quickly ensure the state of charge SOC by not delaying an increase in the amount of regeneration when the state of charge SOC is low.

FIG. 5 corresponds to the case of step S3 to step S5 in FIG. 3, that is, the case where it is determined that the state of charge SOC is higher than or equal to the predetermined value α and an increase in the amount of regeneration is delayed. In FIG. 5, the downshift of the automatic transmission 18 is started at t0 timing, and the clutch pressure (actual pressure) of the engaging-side clutch gradually increases as indicated by the solid line. The required amount of regeneration at this time is the same as that in a state before the shift. When the clutch pressure increases to a predetermined value, inertia phase begins, and the turbine rotation speed Nt increases. Here, a request to increase the amount of regeneration is output at t1 timing; however, an increase in the amount of regeneration is delayed on the basis of the fact that the state of charge SOC is higher than or equal to the predetermined value α. Thus, the required amount of regeneration does not vary in a period from t1 timing to t2 timing at which the downshift is completed. When the downshift of the automatic transmission 18 has been completed at t2 timing, an increase in the amount of regeneration is started. Thus, a shock that occurs in the case where an increase in the amount of regeneration is not delayed and deterioration of drivability due to the shock are suppressed. In addition, delaying an increase in the amount of regeneration causes insufficient regeneration and leads to deterioration of fuel economy; however, when the state of charge SOC of the battery is higher than or equal to the predetermined value α, the necessity to quickly increase the state of charge SOC is low. Thus, when the state of charge SOC of the battery is higher than or equal to the predetermined value α, suppressing deterioration of drivability is given higher priority.

In this way, when a request to increase the amount of regeneration is output at the time of a downshift during regenerative coast traveling, the timing of an increase in the amount of regeneration is changed on the basis of the state of charge SOC. That is, the timing of an increase in the amount of regeneration is changed on the basis of the degree of necessity to carry out charging operation. Specifically, suppressing deterioration of drivability is given higher priority when the state of charge SOC of the battery 46 is higher than or equal to the predetermined value α, and an increase in the amount of regeneration and improvement in fuel economy are given higher priority when the state of charge SOC is lower than the predetermined value α. Thus, it is possible to achieve both suppressing deterioration of drivability and suppressing deterioration of fuel economy at the time of a downshift during regenerative coast traveling.

As described above, according to the present embodiment, when the state of charge SOC of the battery 46 is lower than the predetermined value α, an increase in the amount of regeneration carried out by the electric motor MG is carried out before completion of the downshift, so it is possible to quickly ensure the state of charge SOC. On the other hand, when the state of charge SOC of the battery 46 is higher than or equal to the predetermined value α, an increase in the amount of regeneration is carried out after completion of the downshift. Thus, it is possible to suppress deterioration of drivability at the time of the shift. In this way, by changing the timing of starting an increase in the amount of regeneration on the basis of the state of charge SOC of the battery 46, it is possible to suppress deterioration of drivability and deterioration of fuel economy.

Next, another embodiment of the invention will be described. In the following description, like reference numerals denote portions common to the above-described embodiment, and the description thereof is omitted.

In the above-described embodiment, an increase in the amount of regeneration is delayed to completion of a downshift when the state of charge SOC of the battery 46 is higher than or equal to the predetermined value α, and an increase in the amount of regeneration is immediately carried out when the state of charge SOC is lower than the predetermined value α. Instead, when an increase in the amount of regeneration carried out by the electric motor MG is carried out before completion of a downshift, that is, when the state of charge SOC is lower than the predetermined value α, a period of time from an increase in the amount of regeneration to completion of a downshift may be changed as needed on the basis of the state of charge SOC of the battery 46. Specifically, in the case where an increase in the amount of regeneration carried out by the electric motor MG is carried out before completion of a downshift, when the state of charge SOC of the battery 46 is low, a period of time from an increase in the amount of regeneration to completion of a downshift is set so as to be longer than that when the state of charge SOC is high. That is, as the state of charge SOC of the battery 46 decreases, a period of time from an increase in the amount of regeneration to completion of a downshift is set to be longer.

FIG. 6 shows the correlation between a state of charge SOC and a period of time T from an increase in the amount of regeneration to completion of a downshift. In FIG. 6, when the state of charge SOC is higher than or equal to the predetermined value α, an increase in the amount of regeneration is carried out after completion of a downshift, so the period of time T becomes zero. When the state of charge SOC becomes lower than a predetermined value β, an increase in the amount of regeneration is carried out immediately after a request to increase the amount of regeneration is output, so the period of time T is longest. In a region in which the state of charge SOC falls within the range of the predetermined value β to the predetermined value α, the period of time T reduces as the state of charge SOC increases. That is, when the state of charge SOC of the battery 46 is low, the period of time T is set so as to be longer than that when the state of charge SOC is high. In other words, when the state of charge SOC of the battery 46 is low, the timing of an increase in the amount of regeneration is advanced as compared to that when the state of charge SOC is high.

Incidentally, with the progress of a downshift of the automatic transmission 18, a differential rotation between the transmission input rotation speed Nin and the target rotation speed set as a rotation speed after the shift reduces. Thus, as the timing of an increase in the amount of regeneration during a downshift delays, that is, as the period of time T from an increase in the amount of regeneration to completion of a downshift reduces, a shoal(generated at that time also reduces. In contrast to this, as shown in FIG. 6, when the state of charge SOC is low, the period of time T is set so as to be longer than that when the state of charge SOC is high. Thus, an increase in the amount of regeneration is carried out at earlier timing as the state of charge SOC reduces, so it is possible to ensure the state of charge SOC. In addition, as the state of charge SOC increases, the timing of an increase in the amount of regeneration is delayed, so a shock is suppressed. In this way, in the case where an increase in the amount of regeneration is carried out before completion of a downshift, when the state of charge SOC is low, the period of time T is extended as compared to that when the state of charge SOC is high. Thus, it is possible to suppress deterioration of fuel economy while suppressing a shock due to an increase in the amount of regeneration.

As described above, according to the present embodiment, at the time when an increase in the amount of regeneration carried out by the electric motor MG is carried out before completion of a downshift, when the state of charge SOC of the battery 46 is low, the period of time from an increase in the amount of regeneration to completion of a downshift is extended as compared to that when the state of charge SOC is high. Thus, as the state of charge SOC of the battery 46 reduces, it is possible to quickly ensure the state of charge SOC. In addition, as the state of charge SOC increases, the timing of an increase in the amount of regeneration is more delayed, so it is possible to suppress a shock due to an increase in the amount of regeneration.

The embodiments of the invention are described above with reference to the accompanying drawings; however, the invention is applied in other modes.

For example, in the above-described embodiments, the hybrid vehicle 10 is just one example. Where appropriate, the invention is applicable to a hybrid vehicle that includes an engine and an electric motor, each of which functions as a driving force source, and a transmission and is configured to carry out a downshift of the transmission during regenerative coast traveling carried out by the electric motor.

In the above-described embodiments, the coupling configuration, or the like, of the transmission is not limited as long as the transmission is configured to be able to carry out a coast downshift, and may be modified as needed.

In the above-described embodiments, the torque converter 16 is not always required, and may be omitted.

In the above-described embodiments, it is determined whether a shift has been completed on the basis of whether the input rotation speed Nin of the transmission input shaft has reached the target rotation speed set as a rotation speed after the shift; instead, for example, it may be determined whether a shift has been completed by other means, such as whether an elapsed time from a start of a shift has reached a preset period of time.

In the above-described embodiments, the predetermined value α that is a threshold for the state of charge SOC of the battery 46 is not a constant value, and may vary on the basis of, for example, an ambient temperature, or the like.

In the above-described embodiments, the clutch K0 is of a normally-open type; instead, the clutch K0 may be of a normally-closed type that is engaged in a state where no hydraulic pressure is supplied.

In the above-described embodiments, the predetermined value α is, for example, set to the state of charge SOC at which EV traveling can be carried out for only the preset predetermined period of time; instead, as another mode, for example, the predetermined value α may be changed as needed to, for example, a value near a control upper limit value preset for the battery 46 as a rated value.

In the above-described embodiments, in the correlation between a state of charge SOC and a period of time T from an increase in the amount of regeneration to completion of a downshift, shown in FIG. 6, the period of time linearly varies in a period in which the state of charge SOC changes from the predetermined value β to the predetermined value α; instead, for example, the period of time T may be changed as needed, for example, in a stepwise manner or a curved manner.

The above-described embodiments are only illustrative; the invention may be modified or improved in various forms on the basis of the knowledge of persons skilled in the art.

What is claimed is:

1. A control system for a hybrid vehicle, comprising:
an engine serving as a driving force source;
an electric motor serving as a driving force source;
a transmission provided on a power transmission path between a drive wheel and both the engine and the electric motor;
a battery configured to exchange electric power with the electric motor; and
a controller configured to, when a downshift of the transmission and an increase in an amount of regeneration are carried out during regenerative coast traveling in which regeneration is carried out by the electric motor and when a state of charge of the battery is lower than a predetermined value, increase the amount of regeneration before completion of the downshift, the controller being configured to, when the state of charge of the battery is higher than or equal to the predetermined value, increase the amount of regeneration after completion of the downshift.

2. The control system according to claim 1, wherein
the controller is configured to, when the amount of regeneration is increased before completion of the downshift and when the state of charge of the battery is low, extend a period of time from an increase in the amount of regeneration to completion of the downshift as compared to that when the state of charge of the battery is high.

3. A control method for a hybrid vehicle, the hybrid vehicle including an engine and an electric motor, each of which serves as a driving force source, a transmission provided on a power transmission path between a drive wheel and both the engine and the electric motor, and a battery configured to exchange electric power with the electric motor, the control method comprising:
starting a downshift of the transmission during regenerative coast traveling in which regeneration is carried out by the electric motor;
detecting a request to increase an amount of regeneration carried out by the electric motor;
determining whether a state of charge of the battery is higher than or equal to a predetermined value; and
increasing the amount of regeneration before completion of the downshift when the state of charge of the battery is lower than the predetermined value, and increasing the amount of regeneration after completion of the downshift when the state of charge of the battery is higher than or equal to the predetermined value.

4. The control method according to claim 3, wherein
when the amount of regeneration is increased before completion of the downshift and when the state of charge of the battery is low, a period of time from an increase in the amount of regeneration to completion of the downshift is extended as compared to that when the state of charge of the battery is high.
